(19) United States
(12) Patent Application Publication
(10) Pub. No.: US 2020/0317106 A1
(43) Pub. Date: Oct. 8, 2020

(54) TRUCKER TRAY

(71) Applicants: Curtis O. Smith, Wichita, KS (US); Jo Ann Smith, Wichita, KS (US)

(72) Inventors: Curtis O. Smith, Wichita, KS (US); Jo Ann Smith, Wichita, KS (US)

(21) Appl. No.: 16/374,135

(22) Filed: Apr. 3, 2019

(51) Int. Cl. B60N 3/00

(52) U.S. Cl. CPC B60N 3/002

(57) ABSTRACT

A trucker tray is provided. The trucker tray has a planar tray portion and a perpendicularly joined leg portion. The leg portion provides a lower cutout for snugly engaging an armrest so that a driver of a vehicle can hold their food on the tray portion.

### BACKGROUND OF THE INVENTION

The present invention relates to trucking accessories and, more particularly, a trucker tray adapted to securely hold articles and food, affording truck drivers a sturdy supporting surface from which to eat safely from when driving on the road.

Truck drivers operate under demanding deadlines and so cannot always pulling over to eat, and so they have to eat while driving. Unfortunately, drivers don't have adequate “counter space” when it comes to eating and driving, and so end up placing their food items on the floor, in the passenger seat, or even on the dash board while driving down the road. Such practices can cause a mess where truckers spend their entire day. Also, searching and reaching for food items strewn across the many surfaces of a truck cab can result in the driver taking their eyes off the road.

As can be seen, there is a need for a trucker tray adapted to securely hold articles and food, enabling drivers of all vehicles a sturdy supporting surface from which to eat safely when driving on the road.

### SUMMARY OF THE INVENTION

In one aspect of the present invention, a trucker tray including the following: a tray portion having a planar base portion; a border circumscribed the planar base portion and protruding above an upper surface of the base portion; a leg portion extend from a lower surface of the base portion; a cutout defined along a lower portion of the leg portion, wherein the cutout is dimensioned to abut three surfaces of an armrest.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a top plan view of an exemplary embodiment of the present invention;

FIG. 3 is a front elevation view of an exemplary embodiment of the present invention;

FIG. 4 is a side elevation view of an exemplary embodiment of the present invention; and

FIG. 5 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a trucker tray having a planar tray portion and a perpendicularly joined leg portion. The leg portion provides a lower cutout for snugly engaging an armrest so that a driver of a vehicle can hold their food on the tray portion.

It should be understood by those skilled in the art that the use of directional terms such as upper, lower, top and the like are used in relation to the illustrative embodiments as they are depicted in the figures, the upward direction (or upper) being toward the top of the corresponding figures and a lower direction being toward the bottom of the corresponding figures.

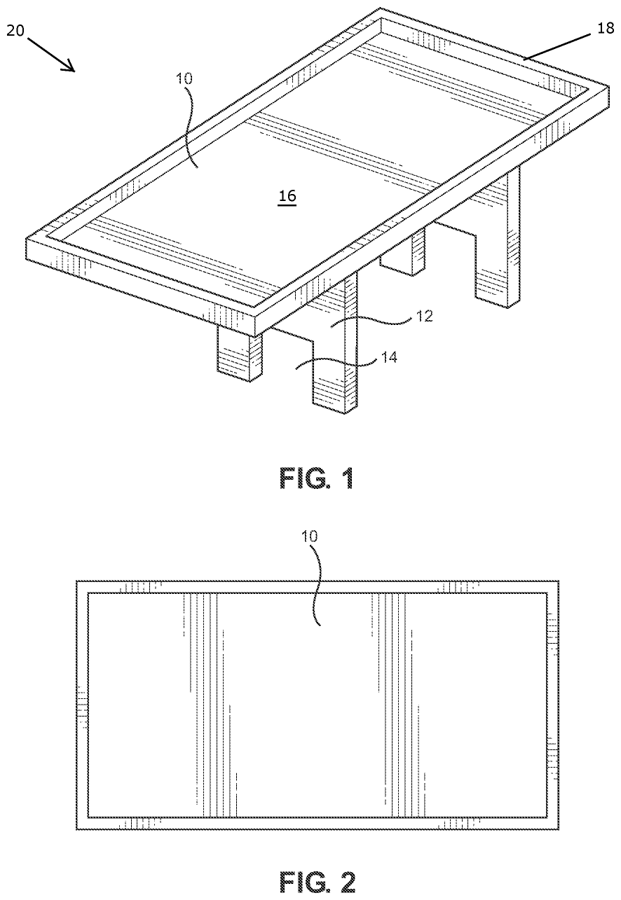

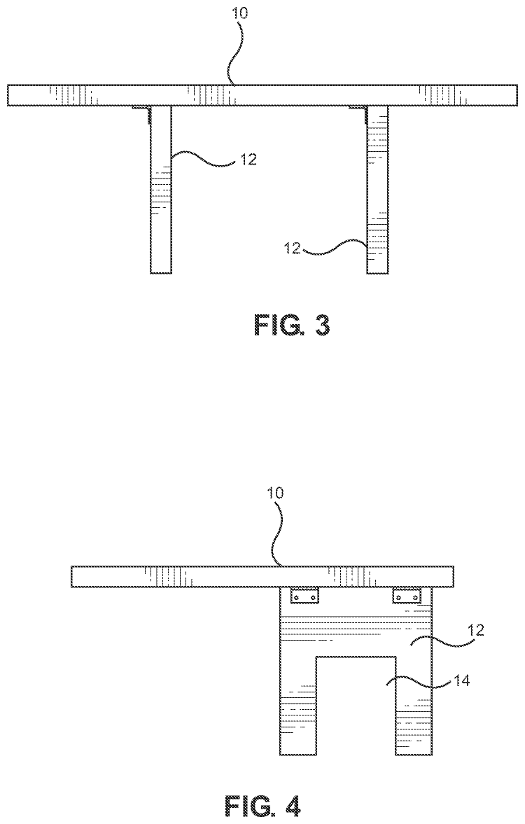

Referring now to FIGS. 1 through 5, the present invention may provide a trucker tray 20 providing a planar tray portion 10 perpendicularly joined to a leg portion 12. In certain embodiments, the leg portion 12 and tray portion 10 may be pivotally joined so that they move between an operable condition (shown in the Figures) and a folded condition for storage.

The tray portion 10 may have a planar base portion 16, which in certain embodiments is six to twelve inches wide by twelve to 24 inches long. Along the periphery, a transversely joined border 18 protrudes approximately one-half to two inches above an upper surface of the base portion 16, for keeping food items and articles from sliding off.

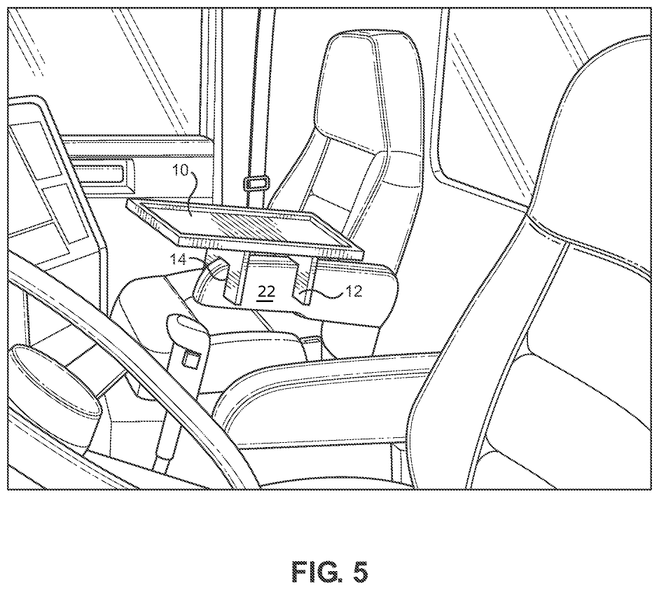

The leg portion 12 that is joined to an underside of the base portion 16 may have the following dimensions to hold the trucker tray 20 on an armrest 22. The leg portion 12 may have a width between four and eight inches and a length of three to six inches long with a one and one-half inch to two and one-half inch cutout 14 defined along a lower portion of the leg portion 12. In any event cutout 14 may be dimensioned and adapted to snugly engage/abut the armrest 22, thereby stabilizing the trucker tray 10 on the armrest 22, as illustrated in FIG. 5.

A method of using the present invention may include the following. The trucker tray 10 disclosed above may be provided. A driver may slide the cutout 14 over and thereby securely engaging the armrest 22. As a result, when driving the trucker tray 10 can hold snacks safely on the base portion 16 instead of the items being placed on the floor, or in the passenger seat, or even on the dash board.

It should be understood, of course, that the foregoing relates to exemplary embodiments of the invention and that modifications may be made without departing from the spirit and scope of the invention as set forth in the following claims.

1. A trucker tray for a vehicle, comprising:
a tray portion having a planar base portion;
a border circumscribing the planar base portion and protruding above an upper surface of the base portion;
at least one leg portion connected to a lower surface of the base portion in such a way to be movable between an operable condition and a folded condition against the lower surface for storage; and
a cutout defined along a lower portion of each leg portion, wherein the cutout is dimensioned to abut three surfaces of an armrest.

2. The trucker tray for a vehicle of claim 1, wherein each leg portion has a length between four and eight inches and a width of three to six inches long, and wherein the cutout extends upward from said lower portion for between one and one-half inches to two and one-half inches.

3. The trucker tray for a vehicle of claim 1, wherein said width of each leg portion is offset entirely on one half of a tray width of the base portion,
whereby the offset facilitates the other half of the tray width extending over a seat associated with the armrest that abuts each cutout in the operable condition.
